(19) United States
(12) Patent Application Publication
(10) Pub. No.: US 2026/0066560 A1
(43) Pub. Date: Mar. 5, 2026

(54) CONNECTOR ASSEMBLY, PLUG CONNECTOR, AND RECEPTACLE CONNECTOR

(71) Applicant: JAPAN AVIATION ELECTRONICS INDUSTRY, LIMITED, Tokyo (JP)

(72) Inventors: Atsushi KOBAYASHI, Tokyo (JP); Toshiro KOBUCHI, Tokyo (JP)

(73) Assignee: JAPAN AVIATION ELECTRONICS INDUSTRY, LIMITED, Tokyo (JP)

(21) Appl. No.: 19/250,602

(22) Filed: Jun. 26, 2025

(30) Foreign Application Priority Data
Aug. 28, 2024 (JP) 2024-146106

(51) Int. Cl. H01R 12/71; H01R 13/424

(52) U.S. Cl. CPC H01R 12/716; H01R 13/424

(57) ABSTRACT

A connector assembly includes a plug connector which includes a pair of first reinforcing brackets incorporated in a first housing and first terminals, and a receptacle connector which includes a pair of second reinforcing brackets incorporated in a second housing and third terminals. The first reinforcing brackets each have a pair of second terminals. The second reinforcing brackets are formed continuously without any gaps to cover an end portion of an island-shaped portion, an end portion of second side walls, and second end walls. The pair of second terminals is formed so as to pinch a region, which covers the island-shaped portion, of each of the second reinforcing brackets when the first terminals and the third terminals are electrically connected to each other by accommodating the island-shaped portion in a first accommodating concave portion.

### TECHNICAL FIELD

The present disclosure relates to a connector which is used in a manner to be mounted on a board as, for example, a board-to-board connector.

### BACKGROUND ART

When a connector assembly which is a board-to-board connector employs a structure in which a plug connector is fitted inside a receptacle connector in a nested pattern, the receptacle connector is often subjected to a relatively larger force than the plug connector.

FIG. 1 is a perspective view of a first connector 300 described in U.S. Patent Application Publication No. 2023/0107849 (hereinafter, referred to as “Patent Literature 1”). FIG. 2 is a perspective view of a second connector 400 described in Patent Literature 1. FIG. 3 is a diagram illustrating an example of a state in which the first connector 300 and the second connector 400 are cut so that a first contact portion 344 of the first connector 300 is included in a connector pair 200 described in Patent Literature 1.

The connector pair 200 described in Patent Literature 1 includes the first connector 300 and the second connector 400.

The first connector 300 includes a base 310, a protruding portion 320, a side wall 330, conductive members 340 and 350, a plurality of signal terminals 360 and 370, and a reinforcing member 380. The first conductive member 340 includes a first reinforcing portion 341, a second reinforcing portion 342, a third reinforcing portion 343, and a first contact portion 344. These portions are integrally formed. In the first conductive member 340, the first reinforcing portion 341, the second reinforcing portion 342, the third reinforcing portion 343, the first contact portion 344, and a coupling portion 346 (not shown) may be integrally formed. By integrally forming the first conductive member 340 into a continuous shape, the rigidity of the first connector 300 is increased, and the rigidity of the connector pair 200 is increased. When the first connector 300 is coupled to the second connector 400, the first contact portion 344 is electrically connected to a movable terminal 450 of the second connector 400. The first contact portion 344 is arranged to surround one end of the protruding portion 320. The first contact portion 344 includes terminal grooves 344a which are electrically connected to the movable terminal 450 of the second connector 400.

The second connector 400 includes a mold 410, a partition wall 420, metal members 430 and 440, the movable terminal 450, and a plurality of signal members 460 and 470. The movable terminal 450 is arranged on the mold 410 and forms an electrical connection with the conductive members 340 and 350 of the first connector 300 when the first connector 300 and the second connector 400 are coupled to each other. The movable terminal 450 is made of a deformable material and therefore, the movable terminal 450 is deformed by the contact portions 344 and 354 when the first connector 300 and the second connector 400 are coupled to each other. For example, the movable terminal 450 is seated in the terminal groove 344a of the first contact portion 344 to form an electrical connection with the first contact portion 344. The mold 410 includes an accommodating portion 412 which accommodates a portion of the movable terminal 450. The accommodating portion 412 is arranged in a region of the partition wall 420, which is adjacent to the metal members 430 and 440, in a manner to surround the movable terminal 450. The accommodating portion 412 provides a space in which the movable terminal 450 moves when the first connector 300 and the second connector 400 are coupled to each other.

The first connector 300 is sometimes subjected to a relatively lager force than the second connector 400 when the first connector 300 and the second connector 400 are coupled to each other. The connector pair 200 of Patent Literature 1 protects the first connector 300, which is subject to relatively large forces, with the movable terminal 450 arranged on the second connector 400 (see Patent Literature 1, paragraphs [0050], [0059], [0064], [0074], [0084], [0085], [0093], [0127], and [0130]).

### SUMMARY OF THE INVENTION

However, in the first connector 300 of Patent Literature 1, there are regions which are not continuous between the second reinforcing portion 342 and the first contact portion 344, or between the third reinforcing portion 343 and the first contact portion 344. Thus, it cannot be said that the first conductive member 340 of Patent Literature 1 necessarily has a sufficiently satisfactory level of rigidity.

Further, the movable terminal 450 of the second connector 400 in Patent Literature 1 is structured so as to cover and pinch the first contact portion 344 from both side surfaces, as illustrated in FIG. 3. The movable terminal 450 is deformed by the contact portion 344 when the first connector 300 and the second connector 400 are coupled to each other. The movable terminal 450 is continuous with the lower end side released in an inverted U-shape in the state of FIG. 3. In the movable terminal 450, a portion corresponding to a bottom portion of the inverted U-shape (the upper portion in FIG. 3) is not covered by any member from above but is formed in a bare state (exposed state). Further, the movable terminal 450 is structured to receive forces from both side surfaces of the contact portion 344 illustrated in FIG. 3, that is, from two parts of the contact portion 344 in fitting with the first connector 300.

Accordingly, the portion corresponding to the bottom portion of the inverted U-shape may be deformed to warp into a U-shape or inverted U-shape due to repeated coupling (fitting) of the first connector 300 and the second connector 400. For example, when the portion corresponding to the bottom portion warps in a U-shape, a contact position with the contact portion 344 is shifted upward. For example, if the contact position is shifted to an R-shaped position of the contact portion 344 in FIG. 3, contact stability may be lost.

The first connector 300 of Patent Literature 1 may include the terminal grooves 344a. In this structure, if the contact force between the movable terminal 450 and the terminal grooves 344a is too strong, repeated coupling (fitting) of the first connector 300 and the second connector 400 may cause warping of the portion of the movable terminal 450 corresponding to the bottom portion of the inverted U-shaped, because the movable terminal 450 is in the bare state (exposed state). This may make it impossible to ensure stable contact at the terminal grooves 344a.

In other words, it may be impossible for the connector pair 200 to ensure the stability of electrical connection between the movable terminal 450 and the first contact portion 344 due to deformation caused by warping of the movable terminal 450.

An object of the present disclosure is to provide a connector assembly which can increase rigidity of a receptacle connector while ensuring electrical connection stability.

A connector assembly which is an example of the present embodiment includes a plug connector and a receptacle connector. The plug connector includes: a pair of first reinforcing brackets, which are incorporated in both respective end portions in a long side direction of a first housing made of resin; and first terminals, which are arranged and held in the first housing between the pair of first reinforcing brackets. The receptacle connector includes: a pair of second reinforcing brackets, which are incorporated in both respective end portions in the long side direction of a second housing made of resin; and third terminals, which are arranged and held in the second housing between the pair of second reinforcing brackets so as to be electrically connected with the first terminals. The first housing includes a pair of first side walls in the long side direction, a pair of first end walls in a short side direction, and a first accommodating concave portion which is formed by at least the pair of first side walls and the pair of first end walls. The second housing includes a pair of second side walls in the long side direction, a pair of second end walls in the short side direction, and an island-shaped portion provided on a position surrounded by the pair of second side walls and the pair of second end walls. The first reinforcing brackets each have a pair of second terminals. The second reinforcing brackets are formed continuously without any gaps to cover an end portion of the island-shaped portion, an end portion of the second side walls, and the second end walls. The pair of second terminals is formed so as to pinch a region, which covers the island-shaped portion, of each of the second reinforcing brackets when the first terminals and the third terminals are electrically connected to each other by accommodating the island-shaped portion in the first accommodating concave portion.

### Effects of the Invention

According to the connector assembly of the present disclosure, rigidity of a receptacle connector can be increased while ensuring electrical connection stability.

### BRIEF DESCRIPTION OF THE DRAWINGS

FIG. 1 is a perspective view of a first connector 300 described in Patent Literature 1.

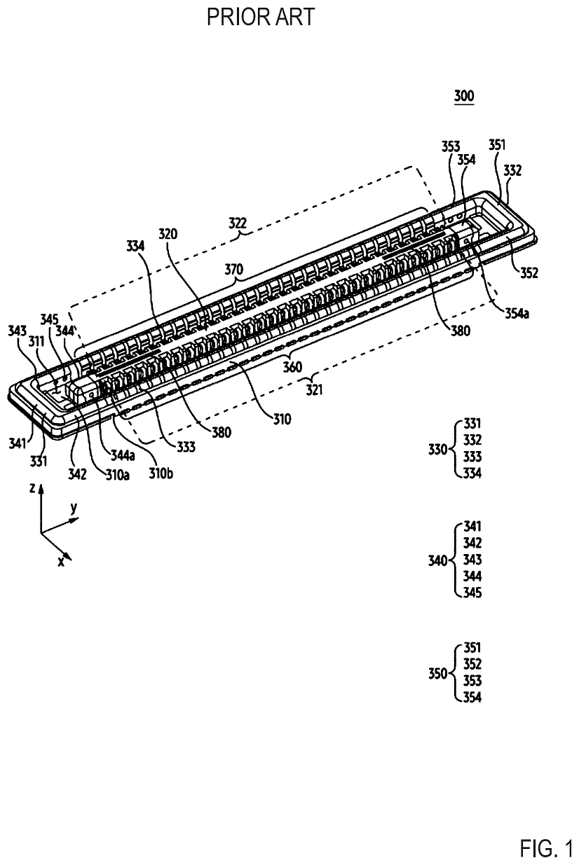

FIG. 2 is a perspective view of a second connector 400 described in Patent Literature 1.

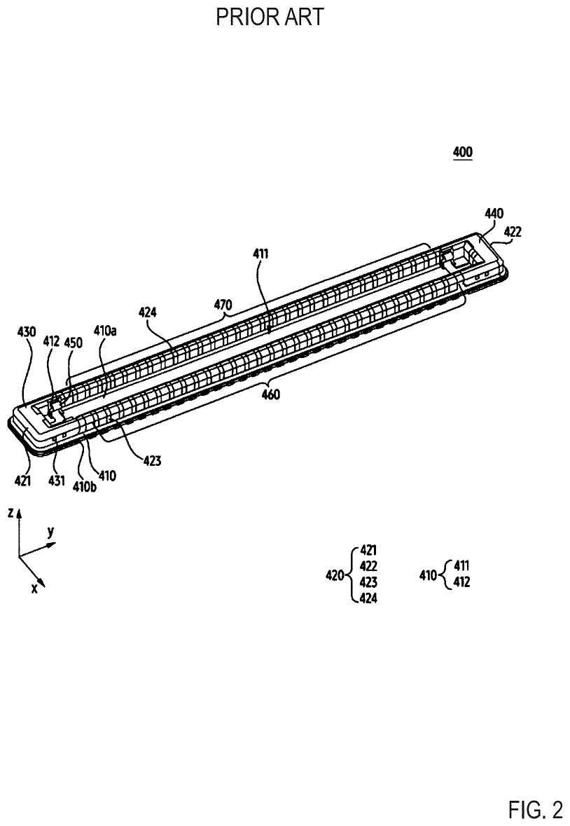

FIG. 3 is a diagram illustrating an example of a state in which the first connector 300 and the second connector 400 are cut so that a first contact portion 344 of the first connector 300 is included in a connector pair 200 described in Patent Literature 1.

FIG. 4 is a perspective view illustrating an example of a plug connector 100A according to an embodiment of the present disclosure.

FIG. 5 is an enlarged plan view illustrating the plug connector 100A except for intermediate portion.

FIG. 6 shows enlarged diagrams illustrating one end portion in a long side direction of the plug connector 100A except for a first reinforcing bracket 30, where A is a plan view and B is a perspective view.

FIG. 7 shows sectional views of the plug connector 100A cut at a surface in a short side direction, where A is a sectional view taken along an H-H line in FIG. 5 and B is a sectional view taken along a C-C line in FIG. 5.

FIG. 8 is a sectional view taken along a K-K line in FIG. 5.

FIG. 9 shows sectional views of the plug connector 100A cut at a surface in the short side direction, where A is a sectional view taken along an I-I line in FIG. 5 and B is a sectional view taken along a J-J line in FIG. 5.

FIG. 10 shows diagrams illustrating the first reinforcing bracket 30, where A is a perspective view and B is a plan view.

FIG. 11 shows diagrams illustrating the first reinforcing bracket 30, where A is an elevational view, B is a left side view, and C is a back view.

FIG. 12 is a perspective view illustrating an example of a receptacle connector according to the embodiment of the present disclosure.

FIG. 13 is an enlarged plan view illustrating a receptacle connector 600A except for an intermediate portion.

FIG. 14 shows enlarged diagrams illustrating one end portion in a long side direction of the receptacle connector 600A except for a second reinforcing bracket 80, where A is a plan view and B is a perspective view.

FIG. 15 shows sectional views of the receptacle connector 600A cut at a surface in a short side direction, where A is a sectional view taken along a D-D line in FIG. 13 and B is a sectional view taken along an E-E line in FIG. 13.

FIG. 16 shows sectional views of the receptacle connector 600A cut at a surface in the long side direction, where A is a sectional view taken along an F-F line in FIG. 13 and B is a sectional view taken along a G-G line in FIG. 13.

FIG. 17 shows sectional views of the receptacle connector 600A cut at a surface in the short side direction, where A is a sectional view taken along an A-A line in FIG. 13 and B is a sectional view taken along a B-B line in FIG. 13.

FIG. 18 shows diagrams illustrating the second reinforcing bracket 80, where A is a perspective view and B is a plan view.

FIG. 19 shows diagrams illustrating the second reinforcing bracket 80, where A is an elevational view, B is a left side view, and C is a back view.

FIG. 20 is a perspective view illustrating a fitting state between the receptacle connector 600A and the plug connector 100A.

FIG. 21 is an enlarged sectional view illustrating a portion on which second terminals 36 of the first reinforcing bracket 30 of the plug connector 100A are positioned in a state in which the receptacle connector 600A and the plug connector 100A are fitted and connected to each other.

### DETAILED DESCRIPTION OF THE EMBODIMENTS

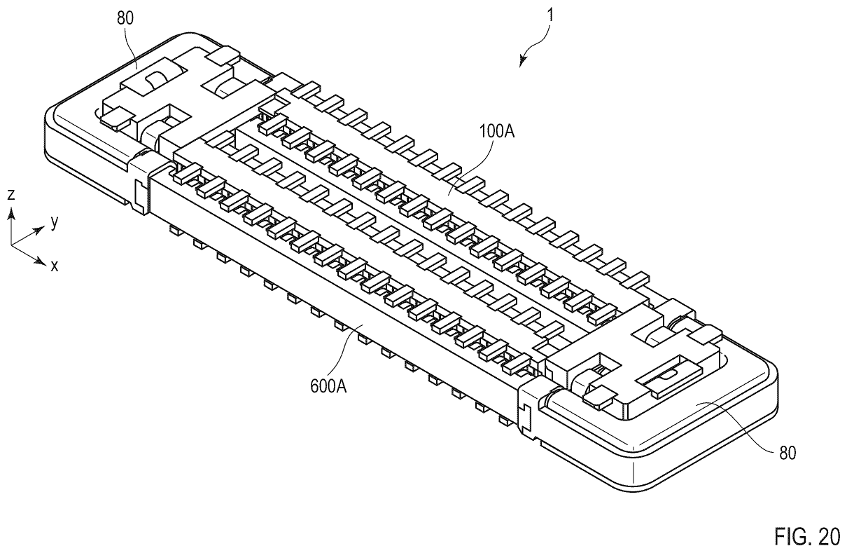

An embodiment of the present disclosure will be described with reference to the accompanying drawings. A connector assembly 1 (see FIG. 20) which is an example of the embodiment of the present disclosure is a connector assembly which includes a plug connector 100A and a receptacle connector 600A.

As described later, the plug connector 100A includes a pair of first reinforcing brackets 30 which are incorporated in both respective end portions in a long side direction of a first housing 10 made of resin, and first terminals 20 which are arranged and held in the first housing 10 between the pair of first reinforcing brackets 30. The receptacle connector 600A includes a pair of second reinforcing brackets 80 which are incorporated in both respective end portions in a long side direction of a second housing 60 made of resin, and third terminals 70 which are arranged and held in the second housing 60 between the pair of second reinforcing brackets 80 so as to be electrically connected with the first terminals 20.

### <<Plug Connector 100A>>

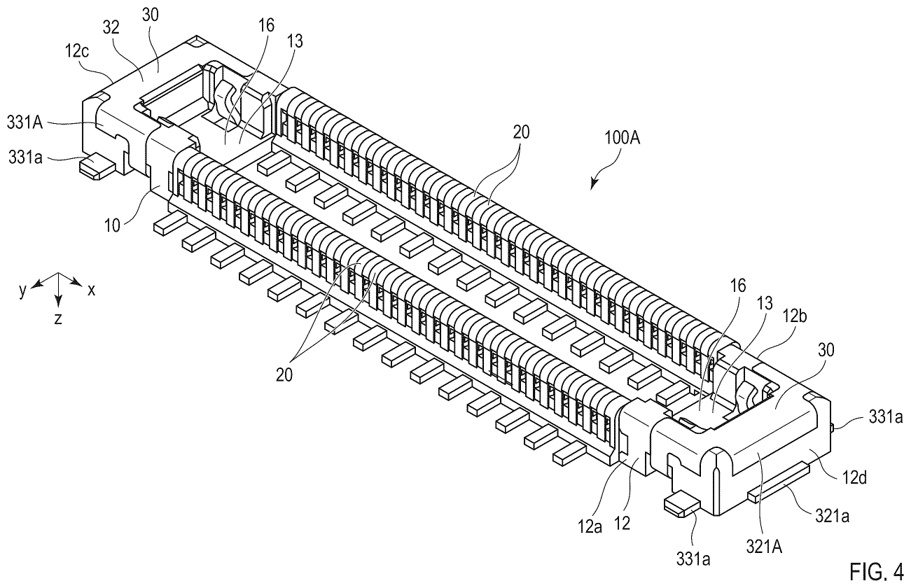

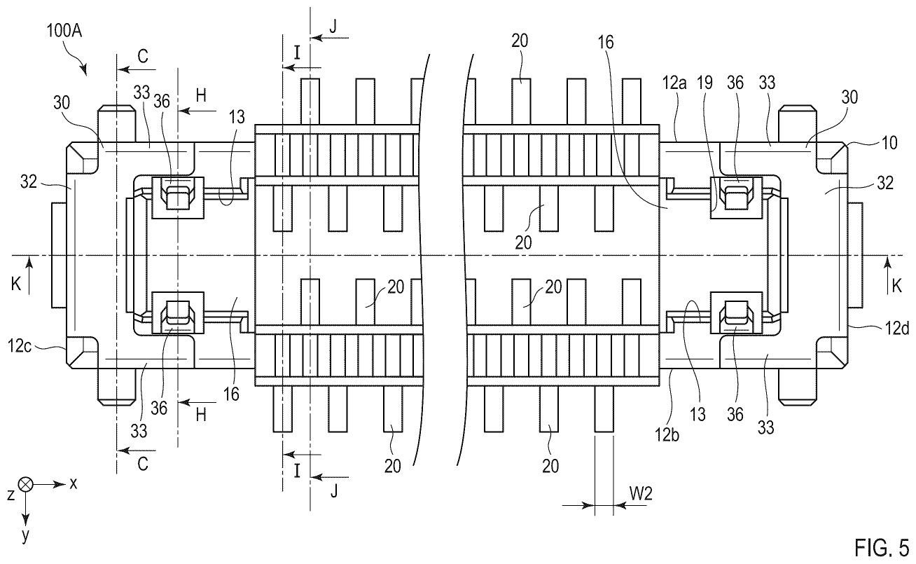

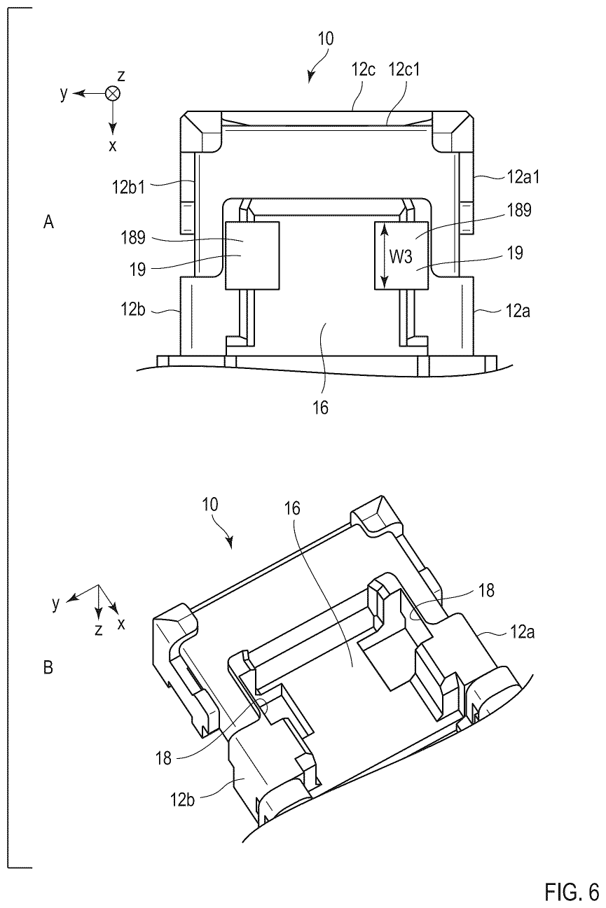

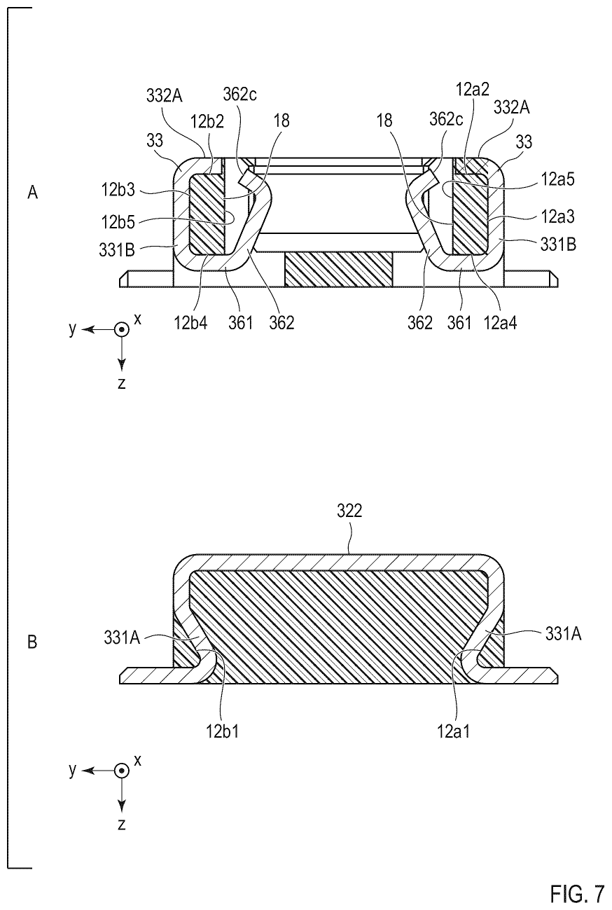

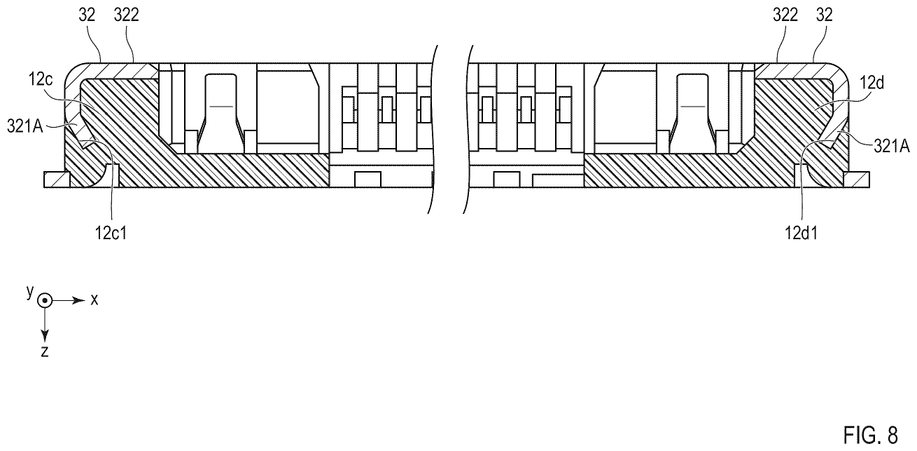

FIG. 4 is a perspective view illustrating an example of the plug connector 100A according to the embodiment of the present disclosure. FIG. 5 is an enlarged plan view illustrating the plug connector 100A except for intermediate portion. FIG. 6 shows enlarged diagrams illustrating one end portion in a long side direction of the plug connector 100A except for the first reinforcing bracket 30, where A is a plan view and B is a perspective view. FIG. 7 shows sectional views of the plug connector 100A cut at a surface in a short side direction, where A is a sectional view taken along an H-H line in FIG. 5 and B is a sectional view taken along a C-C line in FIG. 5. FIG. 8 is a sectional view taken along a K-K line in FIG. 5.

The plug connector 100A is composed of: the first housing 10, which is a housing made of resin; the first terminals 20, which are a number of terminals made of metal; and a pair of first reinforcing brackets 30, which are incorporated in both respective end portions in the long side direction of the first housing 10, as illustrated in FIG. 4.

### <First Housing 10>

The first housing 10 has a long and flat shape, and includes a first peripheral wall 12 and a pair of bottom plate portions 16 which are provided on respective end portion sides in the long side direction.

### (First Peripheral Wall 12)

As illustrated in FIG. 4, the first peripheral wall 12 is composed of a pair of first side walls 12a and 12b, which are peripheral walls in the long side direction (an x-axis direction in FIG. 4), and a pair of first end walls 12c and 12d, which are peripheral walls in the short side direction (a y-axis direction in FIG. 4), and has a rectangular frame shape.

The cross sections of the first side walls 12a and 12b taken along the H-H line (FIG. 5) and their vicinities are formed in a manner such that insides of regions surrounded by respective upper plate portions 332A, leg portions 331B, and first extending portions 361 are filled with insulating material by insert molding in this example, as illustrated in A of FIG. 7, and these are substantially rectangular shaped. The cross sections of the first side walls 12a and 12b taken along the C-C line (FIG. 5) and their vicinities are formed by filling peripheries of leg portions 331A of second guide portions 33 having an S-shaped cross section with insulating material, as illustrated in B of FIG. 7. The leg portions 331A having the S-shaped cross section are thus positioned in the first side walls 12a and 12b, forming opening portions 12al and 12b1.

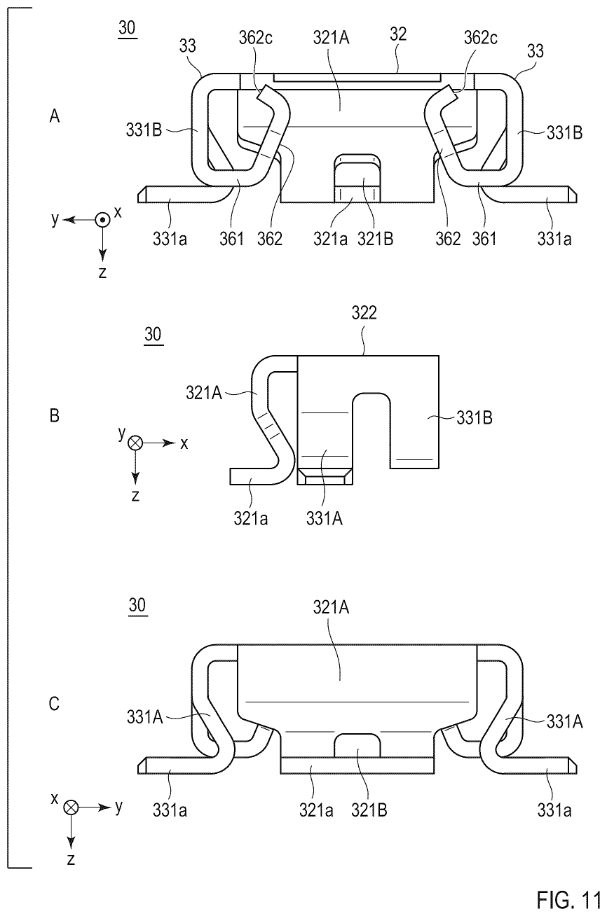

The first end walls 12c and 12d are formed in a manner such that regions surrounded by respective upper plate portions 322 and leg portions 321A are filled with insulating material by insert molding in this example, as illustrated in FIG. 8. Further, outer side portions of portions of the leg portions 321A having an S-shaped cross section are formed in a manner to be filled with insulating material. The leg portions 321A having the S-shaped cross section are thus positioned, forming opening portions 12c1 and 12d1 in the first end walls 12c and 12d. Here, hole portions 321B are formed in the respective leg portions 321A (see FIG. 11).

As illustrated in FIG. 6, in respective first side walls 12a and 12b, concave portions 18, which allow elastic deformation of the second terminals 36 when fitted to the receptacle connector 600A, are formed adjacent to the respective slits 19. The concave portions 18 are formed in a manner such that both end portions of the first side walls 12a and 12b in regions of the concave portions 18 protrude toward the inside of first accommodating concave portion 13. That is, at both ends of the concave portions 18, the first side walls 12a and 12b are formed to have larger widths (in the y-axis direction in FIG. 6). In the present disclosure, a hole portion formed by the region, which is surrounded by the concave portion 18, and the slit 19 described below is referred to as a hole portion 189. That is, a pair of hole portions 189 are formed on both respective end portion sides of the first side walls 12a and 12b to be opposed to each other. Here, the width length (length in the x-axis direction) of the concave portion 18 is a third width W3.

### (Bottom Plate Portion 16)

Both end portions of the first peripheral wall 12 are connected to each other by the bottom plate portion 16. That is, the first side wall 12a, the first side wall 12b, and the first end wall 12c (or the first end wall 12d) are connected on the bottom surface side (the +z direction side in FIG. 6). Accordingly, the first accommodating concave portion 13 (FIG. 4) which accommodates an island-shaped portion 61 of the receptacle connector 600A is formed on the bottom surface side of the first peripheral wall 12. The first accommodating concave portion 13 is composed of at least the first side walls 12a and 12b and the first end wall 12c (or 12d), and has an open end on the upper side (the −z direction side in FIG. 6) with the provision of the bottom plate portion 16.

The bottom plate portion 16 has a pair of slits 19, through which the respective second terminals 36 described later can be inserted, on the left and right of the central portion in A of FIG. 6, adjacent to the respective concave portions 18. The slits 19 are formed at positions at which portions of the second terminals 36 are accommodated when the first reinforcing brackets 30 are incorporated to fit into both respective end portions of the first housing 10.

### <First Terminal 20>

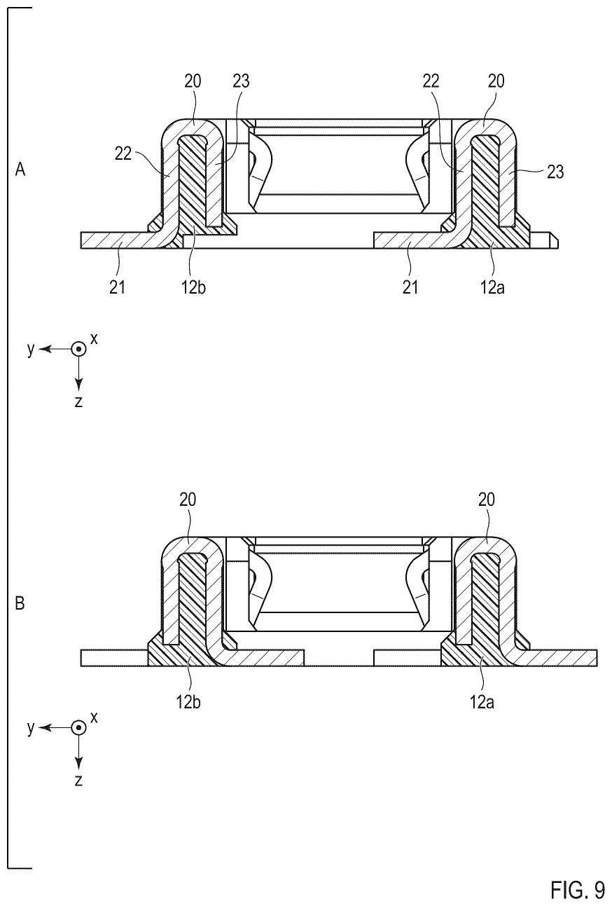

FIG. 9 shows sectional views of the plug connector 100A cut at a surface in the short side direction, where A is a sectional view taken along an I-I line in FIG. 5 and B is a sectional view taken along a J-J line in FIG. 5. The first terminal 20 is a terminal used, for example, as a signal terminal. The first terminals 20 are incorporated in the first housing 10 by insert molding in this example. The first terminals 20 are arranged at predetermined intervals in the long side direction and held in the first housing 10 between the two first reinforcing brackets 30 in a manner to cover the first side walls 12a and 12b.

The first terminals 20 are staggered in this example. When the arrangement of the first terminals 20 is counted as the first row, the second row, . . . from left to right in FIG. 5, a cross section of the plug connector 100A on a portion on which the first terminals 20 in an odd-numbered row are positioned and a cross section of the plug connector 100A on a portion on which the first terminals 20 in an even-numbered row are positioned are as illustrated in FIG. 9.

The first terminals 20 each have the same shape in FIG. 9. The first terminal 20 includes a connection portion 21, a standing portion 22, and a first contact portion 23. The connection portion 21 is positioned on the bottom surface side (the +z direction side in FIG. 9) of the first housing 10 so as to be connected to a board by soldering. The standing portion 22 is raised from the connection portion 21. The first contact portion 23 is bent back from the standing portion 22.

### <First Reinforcing Bracket 30>

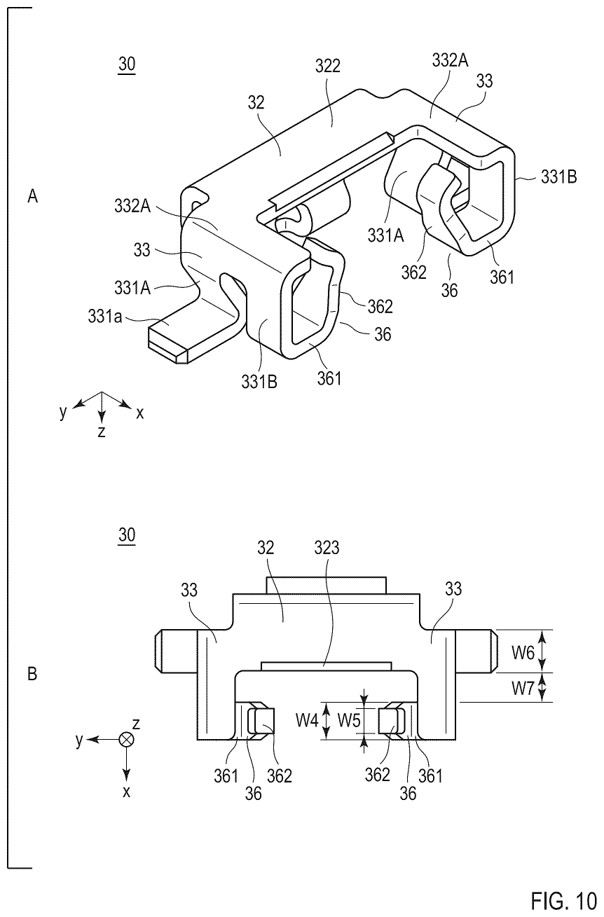

FIG. 10 shows diagrams illustrating the first reinforcing bracket 30, where A is a perspective view and B is a plan view. FIG. 11 shows diagrams illustrating the first reinforcing bracket 30, where A is an elevational view, B is a left side view, and C is a back view. The first reinforcing brackets 30 are incorporated in both respective end portions in the long side direction of the first housing 10 so as to reinforce the first housing 10. The first reinforcing brackets 30 are incorporated in the first housing 10 by insert molding in this example. The first reinforcing brackets 30 includes a pair of second terminals 36 which are formed so that at least portions of the second terminals 36 are accommodated in respective hole portions 189, in this example. The first reinforcing bracket 30 includes a first guide portion 32, a pair of second guide portions 33, and a pair of second terminals 36, as illustrated in FIG. 10.

### (First Guide Portion 32)

The first guide portion 32 is composed of a leg portion 321A and an upper plate portion 322, and covers the first end wall 12c or the first end wall 12d, as illustrated in FIG. 11.

The leg portion 321A extends downward (the +z direction) from an outer end portion in the short side direction (the x-axis direction) of the upper plate portion 322 and also extends in the inner side direction (a direction toward the leg portion 331A in B of FIG. 11) from the middle, in this example. A connection portion 321a is formed at the lower end (the +z direction side in FIG. 11) of the leg portion 321A. The connection portion 321a has a shape bent outward in parallel with the upper plate portion 322 from the lower end of the leg portion 321A. In other words, the leg portion 321A extends in the S-shape, as illustrated in B of FIG. 11.

### (Second Guide Portion 33)

The pair of second guide portions 33 cover both end portions of each of the first side walls 12a and 12b from both ends of the first guide portion 32 toward a mating first reinforcing bracket 30, as illustrated in FIG. 5. Each of the second guide portions 33 includes a leg portion 331A, a leg portion 331B, and an upper plate portion 332A as illustrated in A of FIG. 10, and covers the first side wall 12a or the first side wall 12b.

In this example, the leg portion 331A extends from the end portion of the first guide portion 32 downward (the +z direction in FIG. 11) of the first reinforcing bracket 30 with a width (sixth width W6) shorter than half of the extending length of the second guide portion 33 in the extending direction (the +x direction in FIG. 10) and also extends inward (a direction approaching the leg portion 321A in C of FIG. 11) from the middle. In other words, the leg portion 331A extends in the S-shape, as illustrated in C of FIG. 11. From an end on the extension side of the leg portion 331A, a connection portion 331a is formed in a direction bent back to the outside of the first guide portion 32 (the +y direction side or the −y direction side in FIG. 11). The contact portion 331a is to be connected to a board by soldering. The leg portion 331A extending in the S-shape is thus positioned, forming the opening portions 12a1 and 12b1 in the first side walls 12a and 12b, as illustrated in FIG. 7.

The leg portion 331B extends downward (the +z direction in FIG. 10) of the first reinforcing bracket 30 from a position away from the leg portion 331A by a predetermined length (seventh width W7) in the extending direction of the second guide portion 33, having a width (fourth width W4) wider than the seventh width W7 in this example.

### (Second Terminal 36)

The second terminal 36 is a terminal used, for example, as a power source terminal. The second terminal 36 includes a first extending portion 361 and a second extending portion 362. The second terminal 36 serves as a cantilever, which is fixed to the first side walls 12a and 12b, on the first extending portion 361 side.

The pair of first extending portions 361 each extends from a lower end of the leg portion 331B of the corresponding second guide portion 33 toward a mating second guide portion 33 to a position covering a lower surface 12a4 of the first side wall 12a or a lower surface 12b4 of the first side wall 12b, in close contact with the first side wall 12a or the first side wall 12b, as illustrated in A of FIG. 7. The first extending portion 361 is formed to have the fourth width W4 (FIG. 10) which is larger than a second width W2 (FIG. 5), which is the width of the first terminal 20, and smaller than the third width W3 (FIG. 6), which is the width of the slit 19, in this example. The first extending portion 361 extends from the end portion of the leg portion 331B to the vicinity of the concave portion 18. The first extending portion 361 is thus formed by insert molding to extend in close contact with the first side wall 12a or the first side wall 12b, whereby the first extending portion 361 is fixed to the first side wall 12a or the first side wall 12b. Accordingly, the second extending portion 362 is allowed to elastically deform to function as a cantilever spring.

The second extending portion 362 extends upward from the end portion on the extension side of the first extending portion 361 (toward the hole portion 189). On a free end side of the second extending portion 362, a bent portion 362c (FIG. 7) bent to be closer to the upper plate portion 332A is formed. At least a portion on the bent portion 362c side of the second extending portion 362 is on a position slightly closer to the mating second terminal 36 from the region of the concave portion 18. In other words, the second extending portions 362 of the two second terminals 36, which form cantilevers, extend from the slits 19 and the concave portions 18 toward the inside of the first accommodating concave portion 13 of the first housing 10 (the +y direction or the −y direction in FIG. 10) and upward (the −z direction side in FIG. 10). That is, the pair of second terminals 36 is formed so as to pinch a region, which covers the island-shaped portion 61, of the second reinforcing bracket 80 when the first terminals 20 and the corresponding third terminals 70 (described later) are electrically connected to each other by accommodating the island-shaped portion 61 in the first accommodating concave portion 13. The second extending portion 362 is formed so that the width thereof changes from the fourth width W4 on the first extending portion 361 side to a fifth width W5 (FIG. 10) which is narrower than the fourth width W4. The first housing 10 has the concave portions 18, which allows the second terminals 36 to come into contact with side plate portions 81b of the receptacle connector 600A and elastically deform. The second terminals 36 are formed so that at least portions of the second terminals 36 are accommodated in the respective hole portions 189, in this example.

The second terminals 36 connect with the leg portions 331B. The leg portions 331B connect with the upper plate portions 332A. The upper plate portions 332A, the leg portions 331B, and the first extending portions 361 are formed by insert molding to be in close contact with the first side walls 12a and 12b. Accordingly, the second extending portions 362 are strongly fixed on the first side walls 12a and 12b by the first extending portions 361, the leg portions 331B, and the upper plate portions 332A. In addition to the second terminals 36, the upper plate portions 332A and the leg portions 331B are regarded as second terminals in a broad sense, and are referred to as “second terminals 36”. The second terminals 36′ extend continuously to surround the first side walls 12a and 12b around upper surfaces 12a2 and 12b2, outer surfaces 12a3 and 12b3, lower surfaces 12a4 and 12b4, and inner surfaces 12a5 and 12b5 of the first side walls 12a and 12b. The second terminals 36′ are formed to be in close contact with the upper surfaces 12a2 and 12b2, the outer surfaces 12a3 and 12b3, and the lower surfaces 12a4 and 12b4, as illustrated in FIG. 7.

The second terminal 36′ on the inner surface 12a5 or 12b5 side is formed to extend in a direction away from the inner surface 12a5 or the inner surface 12b5 as it goes toward the open end side of the first accommodating concave portion 13. This allows the second extending portion 362 of the second terminal 36′ to ensure a high spring force to come into contact with the side plate portion 81b.

The second terminals 36′ are provided on the end portions on the first terminal 20 side in the first reinforcing bracket 30. If the second terminals 36′ are provided on positions closer to the first end walls 12c and 12d, the concave portions 18 need to be provided on the central portions in the x-axis direction length of the first reinforcing bracket 30, which may degrade rigidity of the first reinforcing bracket 30 in the x-axis direction. By providing the second terminals 36 on the end portions on the first terminal 20 side in the first reinforcing bracket 30, the above-mentioned degradation in rigidity can be minimized.

The first reinforcing brackets 30 having the above-described shape are incorporated in both respective end portions in the long side direction of the first housing 10. Accordingly, the first end walls 12c and 12d of the first peripheral wall 12 are covered by the respective first guide portions 32, as illustrated in FIG. 8. The first side walls 12a and 12b of the first peripheral wall 12 are covered by the second guide portions 33 in regions of a predetermined length extending from both ends of the first end wall 12c and first end wall 12d toward the mating first end walls 12d and 12c. Namely, the first reinforcing bracket 30 is incorporated in the first housing 10 at a position covering the first end wall 12c (or the first end wall 12d) and portions of the first side walls 12a and 12b, in a state in which the first reinforcing bracket 30 is fitted in the first accommodating concave portions 13 on each of the both end sides in the long side direction of the first housing 10.

### <<Receptacle Connector 600A>>

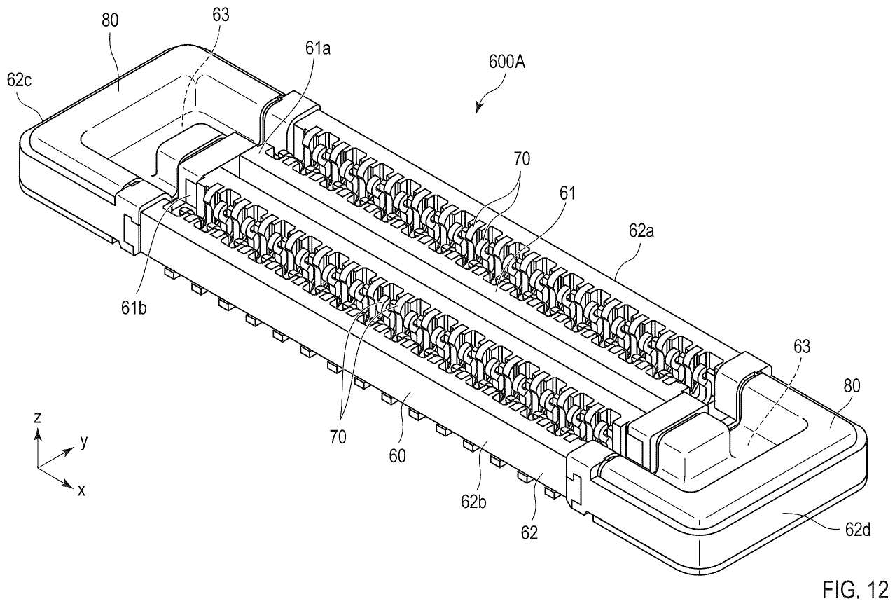

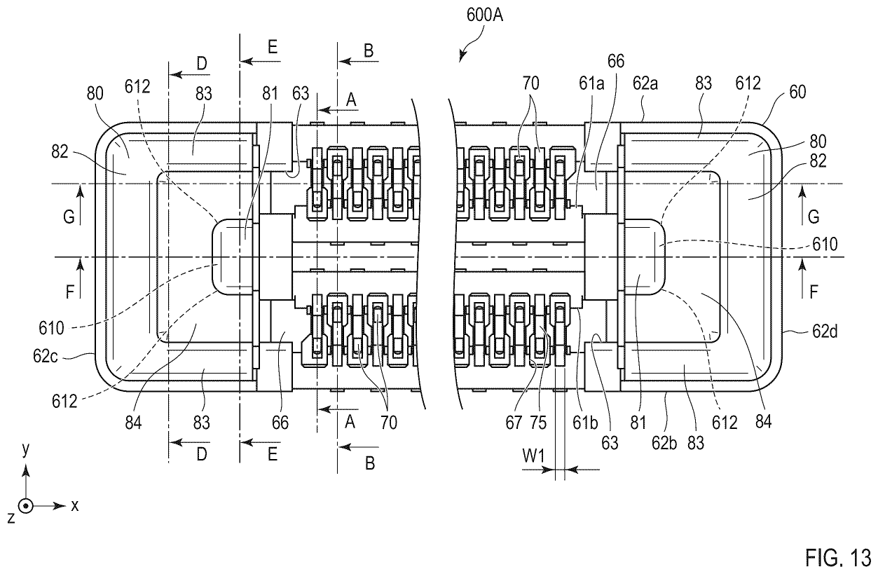

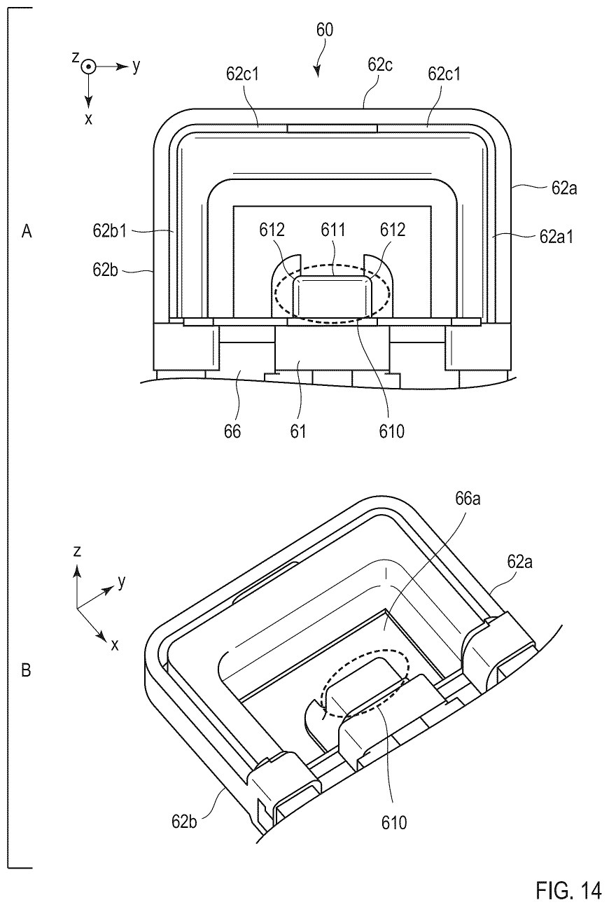

FIG. 12 is a perspective view illustrating an example of the receptacle connector according to the embodiment of the present disclosure. FIG. 13 is an enlarged plan view illustrating the receptacle connector 600A except for an intermediate portion. FIG. 14 shows enlarged diagrams illustrating one end portion in a long side direction of the receptacle connector 600A except for a second reinforcing bracket 80, where A is a plan view and B is a perspective view.

The receptacle connector 600A is composed of: the second housing 60, which is a housing made of resin; the third terminals 70, which are a number of terminals made of metal; and second reinforcing brackets 80, which are provided in respective end portions in the long side direction of the second housing 60, as illustrated in FIG. 12.

### <Second Housing 60>

The second housing 60 has a long and flat shape, and includes the island-shaped portion 61, a second peripheral wall 62, and a bottom plate portion 66.

### (Island-Shaped Portion 61)

The island-shaped portion 61 has a substantially long rectangular parallelepiped shape which extends in the long side direction of the second housing 60 (the x-axis direction in FIG. 12). The island-shaped portion 61 has two corner portions 612 on each of end portions 611, which are both end portions of the island-shaped portion 61, as illustrated in FIG. 14. In the present disclosure, a region including the two corner portions 612 in the end portion 611 (a region within the dotted line in FIG. 14) is referred to as a first region 610.

### (Second Peripheral Wall 62)

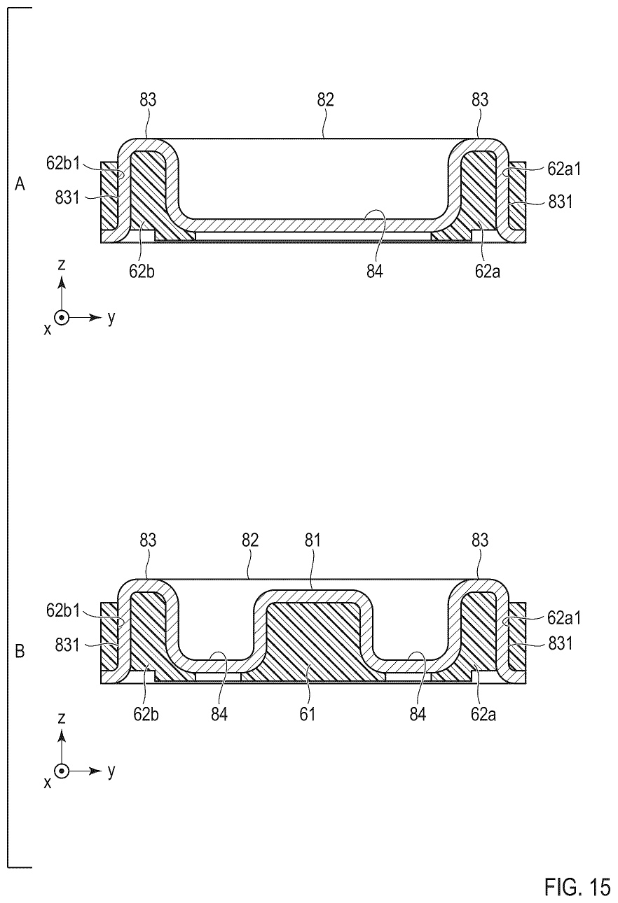

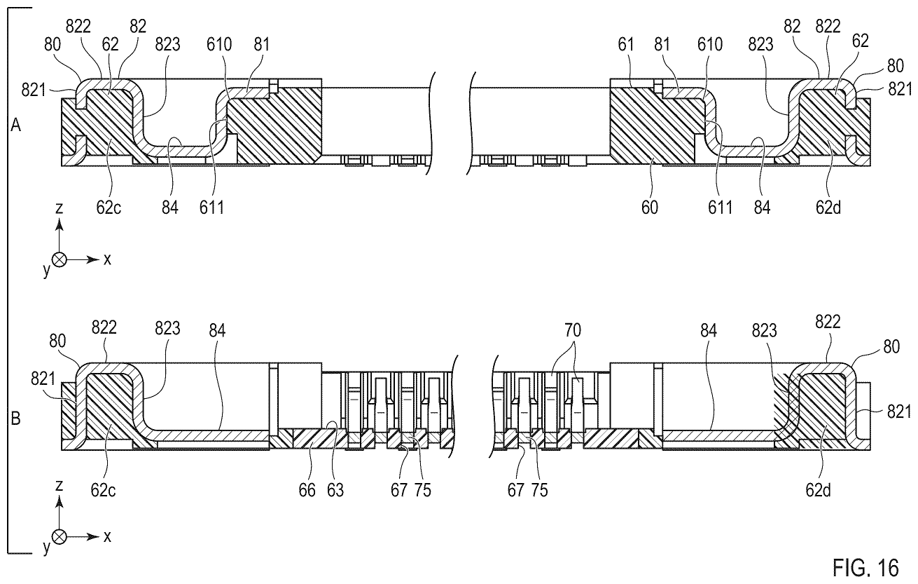

FIG. 15 shows sectional views of the receptacle connector 600A cut at a surface in a short side direction, where A is a sectional view taken along a D-D line in FIG. 13 and B is a sectional view taken along an E-E line in FIG. 13. FIG. 16 shows sectional views of the receptacle connector 600A cut at a surface in the long side direction, where A is a sectional view taken along an F-F line in FIG. 13 and B is a sectional view taken along a G-G line in FIG. 13.

As illustrated in FIG. 12, the second peripheral wall 62 is composed of a pair of second side walls 62a and 62b, which are peripheral walls in the long side direction (the x-axis direction in FIG. 12), and a pair of second end walls 62c and 62d, which are peripheral walls in the short side direction (the y-axis direction in FIG. 12), and has a rectangular frame shape surrounding the island-shaped portion 61.

The second side walls 62a and 62b of the second peripheral wall 62 are formed by insert molding in this example where the inside of a second guide portion 83, which has an inverted U-shape in cross section, and the outside of a leg portion 831 are filled with insulating material, and have a substantially trapezoidal cross section, as illustrated in FIG. 15. The leg portions 831 are thus positioned, forming opening portions 62al and 62b1 in the second side walls 62a and 62b as illustrated in FIG. 14.

The second end walls 62c and 62d of the second peripheral wall 62 are formed by insert molding in this example where the inside of a first guide portion 82, which has an inverted U-shape in cross section, and the outside of a leg portion 821 are filled with insulating material, and have a substantially trapezoidal cross section, as illustrated in FIG. 16. In the second end walls 62c and 62d, the leg portion 821 is thus positioned, forming an opening portion 62cl in the second end wall 62c as illustrated in FIG. 14. An opening portion 62d1 (not shown) is formed in the second end wall 62d.

### (Bottom Plate Portion 66)

The island-shaped portion 61 and the second peripheral wall 62 are connected by the bottom plate portion 66 (A of FIG. 14). Accordingly, a second accommodating concave portion 63 for accommodating a fitting portion of the mating connector is formed between the island-shaped portion 61 and the second peripheral wall 62. The bottom plate portion 66 has an opening portion 66a (B of FIG. 14) in the region, which is surrounded by the second end wall 62c (or the second end wall 62d), the second side walls 62a and 62b, and the first region 610, on one of the both end portions in the long side direction (the x-axis direction in FIG. 14) of the bottom plate portion 66, in this example.

### <Third Terminal 70>

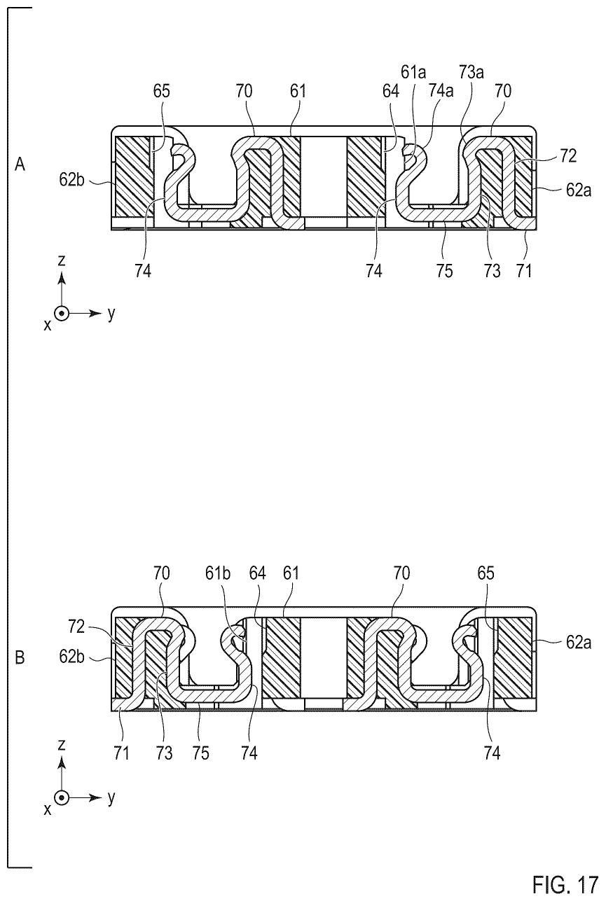

FIG. 17 shows sectional views of the receptacle connector 600A cut at a surface in the short side direction, where A is a sectional view taken along an A-A line in FIG. 13 and B is a sectional view taken along a B-B line in FIG. 13. The third terminals 70 (FIG. 12) are cantilever terminals used, for example, as signal terminals. The third terminals 70 are incorporated in the second housing 60 by insert molding, in this example. The third terminals 70 are located on positions along side surfaces 61a and 61b in the long side direction of the island-shaped portion 61 in the second accommodating concave portion 63 and arranged along the long side direction of the island-shaped portion 61 between the two second reinforcing brackets 80 to be held in the second housing 60.

The third terminals 70 are staggered in this example. When the arrangement of the third terminals 70 is counted as the first row, the second row, . . . from left to right in FIG. 13, a cross section of the receptacle connector 600A on a portion on which the third terminals 70 in an odd-numbered row are positioned and a cross section of the receptacle connector 600A on a portion on which the third terminals 70 in an even-numbered row are positioned are as illustrated in FIG. 17.

The third terminals 70 each have the same shape in FIG. 17. The third terminal 70 includes a connection portion 71, a standing portion 72, a first contact portion 73, a second contact portion 74, and a coupling portion 75. The connection portion 71 is positioned on a bottom surface side (the −z direction side in FIG. 17) of the second housing 60 so as to be connected to a board by soldering. The standing portion 72 is raised from the connection portion 71. The first contact portion 73 is bent back from the standing portion 72. The second contact portion 74 is opposed to the first contact portion 73. The coupling portion 75 couples lower ends of the first contact portion 73 and the second contact portion 74 to each other. A free end of the second contact portion 74 is bent in a semi-circular arc shape to be closer to the first contact portion 73, thus forming a bent portion 74a. Opposed to the bent portion 74a, a protrusion portion 73a is formed on the first contact portion 73 in a protruding manner.

Here, on portions in which the third terminals 70 on an odd-numbered row are located, concave portions 64 and 65 are formed in the side surface 61a of the island-shaped portion 61 and an inner surface of the second side wall 62b respectively, and these concave portions 64 and 65 allow elastic deformation of the respective second contact portions 74 of the third terminals 70. Further, on portions in which the third terminals 70 on an even-numbered row are located, the concave portions 64 and 65 are formed in the side surface 61b of the island-shaped portion 61 and an inner surface of the second side wall 62a respectively, and these concave portions 64 and 65 allow elastic deformation of the respective second contact portions 74 of the third terminals 70. Here, as illustrated in FIG. 13, a slit 67 is formed in a portion on which the coupling portion 75 of each third terminal 70 is positioned in the bottom plate portion 66, positioned on the bottom surface of the second accommodating concave portion 63, of the second housing 60, and the coupling portion 75 is positioned in the slit 67 so as to be allowed to elastically deform with the second contact portion 74.

### <Second Reinforcing Bracket 80>

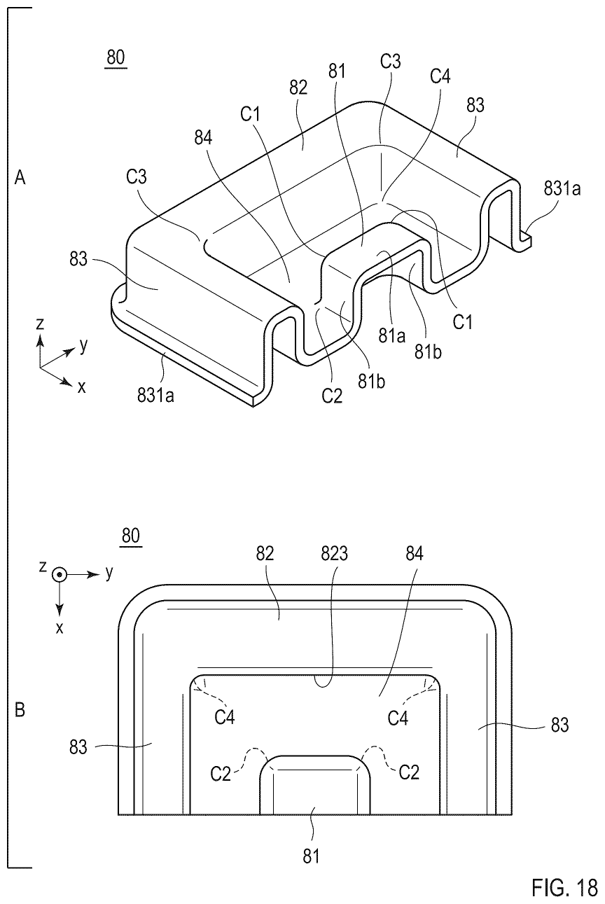

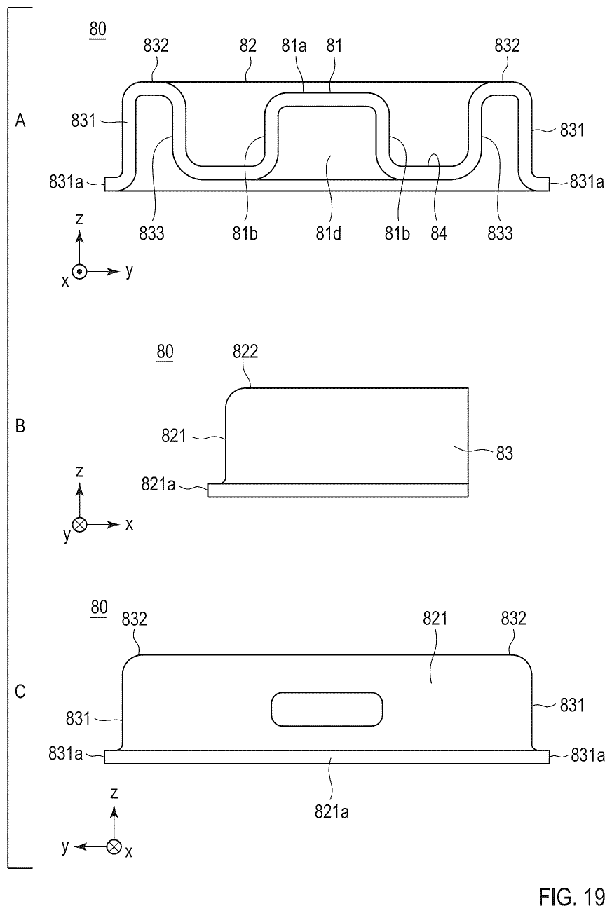

FIG. 18 shows diagrams illustrating the second reinforcing bracket 80, where A is a perspective view and B is a plan view. FIG. 19 shows diagrams illustrating the second reinforcing bracket 80, where A is an elevational view, B is a left side view, and C is a back view. The second reinforcing brackets 80 are incorporated in both respective end portions in the long side direction of the second housing 60 so as to reinforce the second housing 60. The second reinforcing brackets 80 are incorporated in the second housing 60 by insert molding in this example. The second reinforcing bracket 80 includes a protection portion 81, the first guide portion 82, a pair of second guide portions 83, and a bottom plate portion 84, as illustrated in FIG. 18. The second reinforcing brackets 80 in this example are formed to cover the end portions of the island-shaped portion 61, the end portions of the second side walls 62a and 62b, and the second end walls 62c and 62d continuously without any gaps.

### (Protection Portion 81)

The protection portion 81 covers the first region 610 (FIG. 14) including the two corner portions 612 of the end portion 611 in the long side direction of the island-shaped portion 61. The protection portion 81 protrudes upward (the +z direction in FIG. 18) from the bottom plate portion 84 at an opening portion of an angular U-shape formed by the first guide portion 82 and the pair of second guide portions 83. The protection portion 81 is composed of an upper plate portion 81a, a pair of side plate portions 81b, and a rear surface plate portion 81d (A of FIG. 19) which are continued without any gaps. Thus, the protection portion 81 has a box shape whose front surface side (the +x direction side in A of FIG. 18) and lower surface side (the −z direction side in A of FIG. 18) are opened.

### (First Guide Portion 82)

The first guide portion 82 is composed of the leg portion 821 on the outer side, an upper plate portion 822, and a leg portion 823 on the inner side, and covers the second end wall 62c or the second end wall 62d, as illustrated in FIG. 16. The first guide portion 82 and the pair of second guide portions 83 protrude upward (the +z direction in FIG. 18) from the bottom plate portion 84, and each of the three sides forming the angular U-shape has an inverted U-shape in cross section.

The lower end (the −z direction side in B of FIG. 19) of the leg portion 821 is provided with a connection portion 821a. The connection portion 821a is positioned slightly below (the −z direction side in A of FIG. 19) the bottom plate portion 84 and has a shape bent outward in parallel with the bottom plate portion 84.

### (Second Guide Portion 83)

The pair of second guide portions 83 cover the second side walls 62a and 62b from both ends of the first guide portion 82 toward a mating second reinforcing bracket 80 up to a position aligned with the protection portion 81, as illustrated in FIGS. 18 and 19. The second guide portion 83 is composed of the leg portion 831 on the outer side, an upper plate portion 832, and a leg portion 833 on the inner side, and covers the second side wall 62a or the second side wall 62b.

The lower end (the −z direction side in A of FIG. 19) of the leg portion 831 is provided with a connection portion 831a. Each of the connection portions 831a is positioned slightly below (the −z direction side in A of FIG. 19) the bottom plate portion 84 and has a shape bent outward in parallel with the bottom plate portion 84. The connection portion 831a is connected to the connection portion 821a at one end thereof at the position where the first guide portion 82 and the second guide portion 83 are connected to each other.

### (Bottom Plate Portion 84)

The bottom plate portion 84 integrally connects the protection portion 81, the first guide portion 82, and the pair of second guide portions 83 by covering a predetermined region on each of both end portions in the long side direction (the x-axis direction in FIG. 13) of the bottom plate portion 66. Respective lower end sides (the −z direction side in A of FIG. 18) of the leg portion 823, the pair of leg portions 833, the rear surface plate portion 81d, and the pair of side plate portions 81b are integrally connected with the bottom plate portion 84.

Thus, the first guide portion 82 and the pair of second guide portions 83 form the angular U-shape in plan view, as illustrated in B of FIG. 18, and the protection portion 81 is positioned in the inside of the angular U-shape of the first guide portion 82 and the pair of second guide portions 83, which form the angular U-shape in plan view. The first guide portion 82 and the pair of second guide portions 83 are formed by drawing, in this example. The protection portion 81 is formed by drawing, in this example. Namely, the first guide portion 82 and the pair of second guide portions 83, and the protection portion 81 are formed by double drawing of sheet metal, in this example. By the double drawing of sheet metal, the bottom plate portion 84 is formed so that there is no gap of sheet metal between the bottom plate portion 84 and each of the first guide portion 82, the pair of second guide portions 83, and the protection portion 81.

### <<Fitting of Connector and Mating Connector>>

FIG. 20 is a perspective view illustrating a fitting state between the receptacle connector 600A and the plug connector 100A. FIG. 20 does not illustrate respective boards on which the receptacle connector 600A and the plug connector 100A are mounted. In a fitted state of the receptacle connector 600A and the plug connector 100A, the plug connector 100A is fitted into the second accommodating concave portion 63 of the receptacle connector 600A so as to be connected with the receptacle connector 600A.

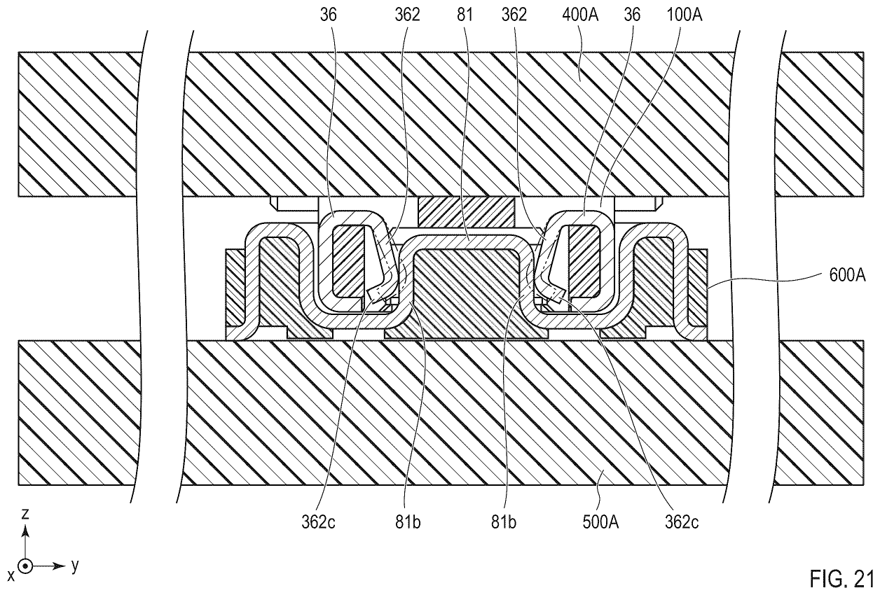

FIG. 21 is an enlarged sectional view illustrating a portion on which the second terminals 36 of the first reinforcing bracket 30 of the plug connector 100A are positioned in a state in which the receptacle connector 600A and the plug connector 100A are fitted and connected to each other. FIG. 21 also illustrates a board 500A and a board 400A on which the receptacle connector 600A and the plug connector 100A are mounted respectively. As illustrated in FIG. 21, the second extending portions 362 of the two second terminals 36 included in the first reinforcing bracket 30 of the plug connector 100A are brought into contact with the side plate portions 81b included in the second reinforcing bracket 80 of the receptacle connector 600A. As a result, the second extending portions 362 are displaced from the positions indicated by the two-dot chain lines in FIG. 21 to the positions indicated by the solid lines.

The configurations of the receptacle connector 600A and the plug connector 100A in the connector assembly 1 as an example of the connector according to the present disclosure has been described above. The fitting state between the receptacle connector 600A and the plug connector 100A has also been described. According to the configuration of the connector assembly 1 of the present disclosure, the following can be said.

The second reinforcing brackets 80 of the receptacle connector 600A are formed continuously without any gaps in a manner to cover the end portions of the island-shaped portion 61, the end portions of the second side walls 62a and 62b, and the second end walls 62c and 62d. In other words, in the second reinforcing bracket 80, the protection portion 81, the first guide portion 82, and the pair of second guide portions 83 are integrally connected to the bottom plate portion 84 without any gaps. Accordingly, the second reinforcing bracket 80 has a structure which ensures high rigidity to be able to prevent deformation and damage of the protection portion 81, the first guide portion 82, and the second guide portions 83.

The second reinforcing bracket 80 includes the bottom plate portion 84 which is not found in Patent Literature 1 and which integrally connects the protection portion 81, the first guide portion 82, and the pair of second guide portions 83 without any gaps. In this regard, the second reinforcing bracket 80 has a structure which ensures high rigidity. Further, for example, if the second reinforcing bracket 80 is formed three-dimensionally from a single sheet metal by double drawing, the second reinforcing bracket 80 will have an uneven thickness, with the thinnest thickness at the corner portions thereof. Therefore, the strength of the corner portions of the protection portion 81 (a pair of corner portions C1 illustrated in A of FIG. 18) and the corner portions formed by the first guide portion 82 and the pair of second guide portions 83 (a pair of corner portions C3 illustrated in A of FIG. 18) is reduced, making the corner portions more easily deformed and damaged. The lower end sides of the corner portions C1 of the protection portion 81 (a pair of corner portions C2 illustrated in FIG. 18) and the lower end sides of the corner portions C3 formed by the first guide portion 82 and the pair of second guide portions 83 (a pair of corner portions C4 illustrated in FIG. 18) are continuously connected to the bottom plate portion 84 without any gaps, which can prevent deformation and damage of the protection portion 81, the first guide portion 82, and the second guide portions 83.

The pair of second terminals 36 of the plug connector 100A is formed so as to pinch the region, which covers the island-shaped portion 61, of the second reinforcing bracket 80 when the first terminals 20 and the corresponding third terminals 70 are electrically connected to each other by accommodating the island-shaped portion 61 of the receptacle connector 600A in the first accommodating concave portion 13.

In other words, the first reinforcing bracket 30 includes the pair of second terminals 36 which are formed so that at least portions of the second terminals 36 are accommodated in respective hole portions 189, in this example. The respective second terminals 36 are connected to the first side walls 12a and 12b in closely contacted manner, and the second terminals 36 are each structured as separate cantilevers. The fixed end sides of the second terminals 36 are hardened with resin in this example, and each of the second terminals 36 has a single contact point where each of the second terminals 36 receives force.

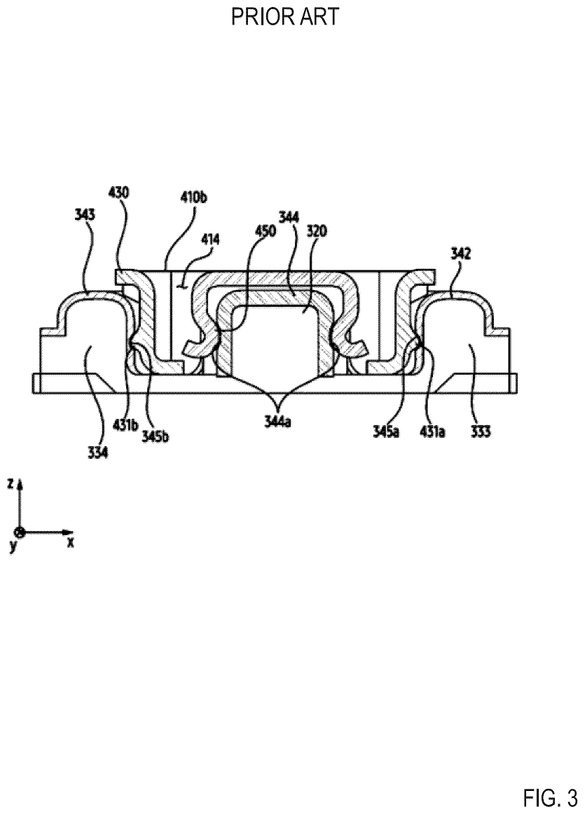

In other words, the first reinforcing bracket 30 does not employ the structure of the movable terminal 450 of Patent Literature 1 which has the lower end side released to be in the inverted U-shape and receives forces from two points and in which the portion corresponding to the bottom portion (the portion on the upper side in FIG. 3) of the inverted U-shape is in a bare state (exposed state) to be continuously and integrally formed as the movable terminal 450. Therefore, there is less risk of warping deformation due to repeated coupling (fitting), compared to the technology of Patent Literature 1. Accordingly, the connector assembly 1 of the present disclosure including the second terminals 36 in the plug connector 100A can ensure electrical connection stability.

The plug connector 100A according to the present disclosure includes the second terminals 36 having the above-described structure. Therefore, it is unnecessary to provide the function of the second terminal 36 to the receptacle connector 600A, and the receptacle connector 600A, which is subject to relatively large forces compared to the plug connector 100A, can be provided with the second reinforcing bracket 80 which ensures high rigidity as described above.

The upper plate portions 332A, the leg portions 331B, and the first extending portions 361 are formed by insert molding in close contact with the first side walls 12a and 12b in this example. The second extending portions 362 are cantilevers which are strongly fixed to the first side walls 12a and 12b by the first extending portions 361, the leg portions 331B, and the upper plate portions 332A. That is, the second terminal 36′ is structured in a manner to be drawn around from the outside of the first side walls 12a and 12b to be fixed firmly. Thus, the pair of second terminals 36′ can ensure more stable connection with the side plate portion 81b.

As described above, according to the connector assembly of the present disclosure, rigidity of the receptacle connector can be increased while ensuring electrical connection stability.

The embodiment of the present disclosure has been described above. Although the second reinforcing bracket 80 has been described as being formed by double drawing, the second reinforcing bracket 80 of the present disclosure is not limited to this. Other manufacturing methods may be employed as long as the second reinforcing bracket 80 having the same structure can be formed. Although the plug connector 100A and the receptacle connector 600A have been described as being obtained by insert molding, the plug connector 100A and the receptacle connector 600A of the present disclosure are not limited to this, and may be implemented by other manufacturing methods as long as similar connectors can be obtained. Although the second terminal 36 is accommodated in the hole portion 189 of the first housing 10 in the embodiment of the present disclosure, the connector assembly of the present disclosure does not require a hole portion penetrating through the first housing 10 like the hole portion 189. The first reinforcing bracket 30 may be structured so that the second terminals 36 are not continuously extended to surround the first side walls 12a and 12b as the second terminal 36′ described above but are directly extended from the inner surfaces 12a5 and 12b5 sides of the first side walls 12a and 12b, for example, whereby the regions for the hole portions 189 may be structured as “recessed portions”, which do not penetrate, and portions of the second terminals 36 may be accommodated in the recessed portions. Alternatively, the first housing 10 may be structured without having such a hole portion or a recessed portion, as long as the second terminal 36 acts as a cantilever (cantilever spring). In addition, it goes without saying that the above-described connector assembly 1 can be modified as appropriate without departing from the spirit and scope of the present disclosure.

The foregoing description of the embodiment of the invention has been presented for the purpose of illustration and description. It is not intended to be exhaustive and to limit the invention to the precise form disclosed. Modifications or variations are possible in light of the above teaching. The embodiment was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A connector assembly comprising:
a plug connector which includes a pair of first reinforcing brackets, the pair of first reinforcing brackets being incorporated in both respective end portions in a long side direction of a first housing made of resin, and first terminals, the first terminals being arranged and held in the first housing between the pair of first reinforcing brackets; and
a receptacle connector which includes a pair of second reinforcing brackets, the pair of second reinforcing brackets being incorporated in both respective end portions in the long side direction of a second housing made of resin, and third terminals, the third terminals being arranged and held in the second housing between the pair of second reinforcing brackets so as to be electrically connected with the first terminals, wherein
the first housing includes a pair of first side walls in the long side direction, a pair of first end walls in a short side direction, and a first accommodating concave portion which is formed by at least the pair of first side walls and the pair of first end walls,
the second housing includes a pair of second side walls in the long side direction, a pair of second end walls in the short side direction, and an island-shaped portion provided on a position surrounded by the pair of second side walls and the pair of second end walls,
the first reinforcing brackets each have a pair of second terminals,
the second reinforcing brackets are formed continuously without any gaps to cover an end portion of the island-shaped portion, an end portion of the second side walls, and the second end walls, and
the pair of second terminals is formed so as to pinch a region, the region covering the island-shaped portion, of each of the second reinforcing brackets when the first terminals and the third terminals are electrically connected to each other by accommodating the island-shaped portion in the first accommodating concave portion.

2. The connector assembly according to claim 1, wherein
the first housing further includes a pair of hole portions which are formed on both respective end portion sides of the first side walls to be opposed to each other, and
the pair of second terminals are formed so that at least respective portions of the pair of second terminals are accommodated in the hole portions.

3. The connector assembly according to claim 1, wherein
each of the second terminals is formed to extend continuously around an upper surface, an outer surface, a bottom surface, and an inner surface of each of the first side walls and be in close contact with each of the upper surface, the outer surface, and the bottom surface, and a portion, the portion being closer to the inner surface, of the each of the second terminals is formed to extend in a direction away from the inner surface, toward an open end side of the first accommodating concave portion.

4. The connector assembly according to claim 1, wherein
the second terminals are provided on an end portion, the end portion being closer to the first terminals, in each of the first reinforcing brackets.

5. A plug connector which can be fitted to a receptacle connector and in which
the receptacle connector is composed of a second housing which is made of resin and includes at least a pair of second side walls in a long side direction, a pair of second end walls in a short side direction, and an island-shaped portion provided on a position surrounded by the pair of second side walls and the pair of second end walls, a pair of second reinforcing brackets which are incorporated in both respective end portions in the long side direction of the second housing, and third terminals which are arranged and held in the second housing between the pair of second reinforcing brackets, and the second reinforcing brackets are formed continuously to cover an end portion of the island-shaped portion, an end portion of the second side walls, and the second end walls,
the plug connector comprising:
a first housing which is made of resin and includes a pair of first side walls in the long side direction, a pair of first end walls in the short side direction, and a first accommodating concave portion which is formed by at least the pair of first side walls and the pair of first end walls;
a pair of first reinforcing brackets which are incorporated in both respective end portions in the long side direction of the first housing and each have a pair of second terminals; and
first terminals which are arranged and held in the first housing between the pair of first reinforcing brackets so as to be electrically connected with the third terminals, wherein
the pair of second terminals is formed so as to pinch a region, the region covering the island-shaped portion, of each of the second reinforcing brackets when the first terminals and the third terminals are electrically connected to each other by accommodating the island-shaped portion in the first accommodating concave portion.

6. A receptacle connector which can be fitted to a plug connector and in which
the plug connector includes a first housing which is made of resin and includes a pair of first side walls in a long side direction, a pair of first end walls in a short side direction, and a first accommodating concave portion which is formed by at least the pair of first side walls and the pair of first end walls, a pair of first reinforcing brackets which are provided in respective end portions in the long side direction of the first housing and each have a pair of second terminals, and first terminals which are arranged and held in the first housing between the pair of first reinforcing brackets,
the receptacle connector comprising:
a second housing which includes at least a pair of second side walls in the long side direction, a pair of second end walls in the short side direction, and an island-shaped portion provided on a position surrounded by the pair of second side walls and the pair of second end walls;
a pair of second reinforcing brackets which are formed continuously without any gaps to cover an end portion of the island-shaped portion, an end portion of the second side walls, and the second end walls; and
third terminals which are arranged and held in the second housing between the pair of second reinforcing brackets so as to be electrically connected with the first terminals, wherein
each of the second reinforcing brackets is structured in a manner such that the pair of second terminals pinch a region, the region covering the island-shaped portion, when the first terminals and the third terminals are electrically connected to each other by accommodating the island-shaped portion in the first accommodating concave portion.
